(19) United States
(12) Patent Application Publication
(10) Pub. No.: US 2011/0250578 A1
(43) Pub. Date: Oct. 13, 2011

(54) VENTILATOR TEST LUNG AND TRIGGER ASSEMBLY

(75) Inventor: Ian Pappin, Edmonton (CA)

(73) Assignee: NORTHERN ALBERTA INSTITUTE OF TECHNOLOGY, Edmonton (CA)

(21) Appl. No.: 12/759,618

(22) Filed: Apr. 13, 2010

(51) Int. Cl. G09B 23/32

(52) U.S. Cl. 434/265

(57) ABSTRACT

A simulated mechanical respiratory trigger and test lung have been developed. The trigger in one embodiment is capable of triggering a variety of mechanical ventilators to deliver predetermined respiratory rates that simulate a spontaneously breathing patient. This permits the student/health care provider to respond to this spontaneous effort and optimize mechanical ventilator settings. The test lung in an embodiment is capable of varying the simulated patient pulmonary compliance in increments not previously available.

### TECHNICAL FIELD

Test lungs for use with ventilators

### BACKGROUND

Test lungs are used in the education of respiratory therapy students in a laboratory setting. These labs include the use of a variety of mechanical ventilators currently in use in critically ill, post-operative, and chronically ill patients. Test lungs are available but current systems either do not offer adjustable pulmonary compliance (stiffer or floppier patient lungs) or utilize mechanical devices such as springs that are cumbersome to adjust in real time simulation or offer a limited number of predetermined settings. These systems also tend not to incorporate a trigger device. A trigger device permits the inanimate test lung to initiate a breath by generating an inspiratory flow through the use of applied suction to the breathing system that includes both the lung simulator and the mechanical ventilator of choice. This inspiratory flow is sensed by the mechanical ventilator as a patient effort through the use of flow sensing components and will then respond as it would in human patient use by delivering a mechanical breath.

### SUMMARY

A simulated mechanical respiratory trigger and test lung have been developed. The trigger in one embodiment is capable of triggering a variety of mechanical ventilators, as a spontaneously breathing patent would, to deliver predetermined respiratory support. This permits the student/health care provider to respond to this spontaneous effort and optimize mechanical ventilator settings. The test lung in an embodiment is capable of varying the simulated patient pulmonary dynamic compliance in increments not previously available to the knowledge of the inventor.

Thus in an embodiment, there is provided a test lung for a ventilator, the test lung comprising a rigid container having fixed walls, the rigid container being pressure tight to a working pressure above atmospheric pressure; an inflow line in a wall of the rigid container for connecting to a hose from a ventilator; at least a first expandable chamber disposed within the rigid container, the first expandable chamber being connected to receive gas passing through the inflow line; and a valve arrangement disposed in one or more walls of the rigid container, the valve arrangement providing controlled gas flow into and out of the rigid container.

In another embodiment, there is provided a pneumatic trigger for a ventilator, the pneumatic trigger comprising: at least a trigger hose connectable to a ventilator output; a gas operated timing mechanism connected via a controller on the trigger hose to allow or block flow through the trigger hose according to settings of the timing mechanism; and a vacuum generator on the trigger hose to provide suction on the trigger hose when the controller is set to allow flow through the trigger hose.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a diagram illustrating an embodiment of a test lung; and

FIG. 2 is a schematic showing an embodiment of a pneumatic control circuit providing a pneumatic trigger and variable compliance for the test lung.

### DETAILED DESCRIPTION

Immaterial modifications may be made to the embodiments described here without departing from what is covered by the claims.

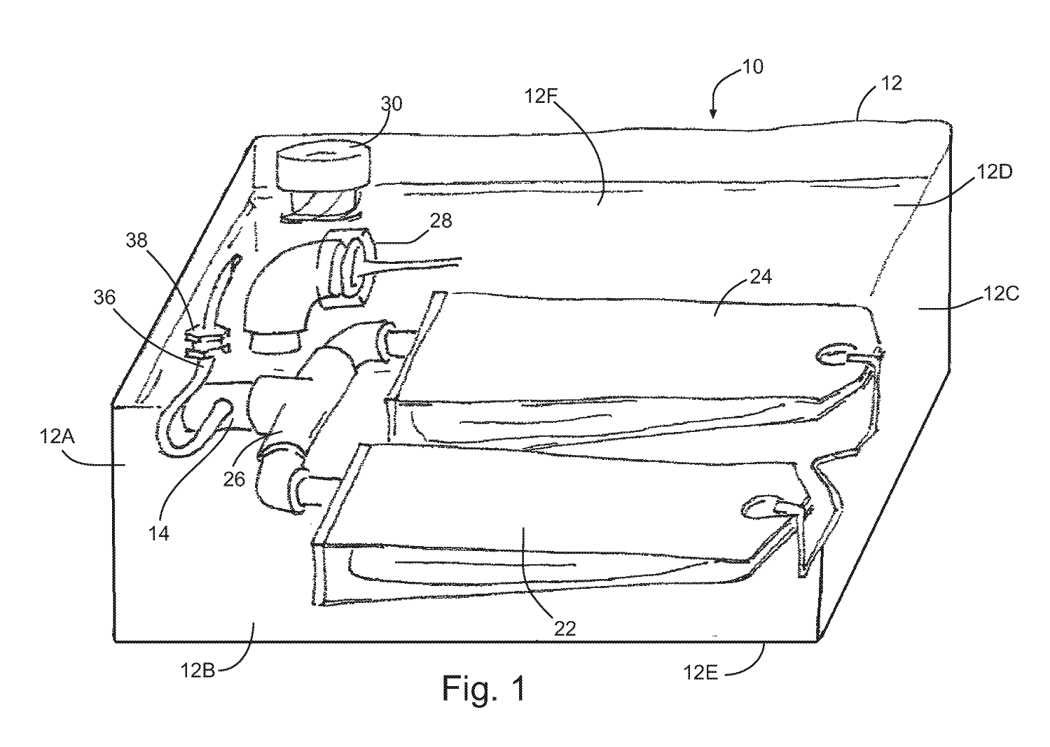

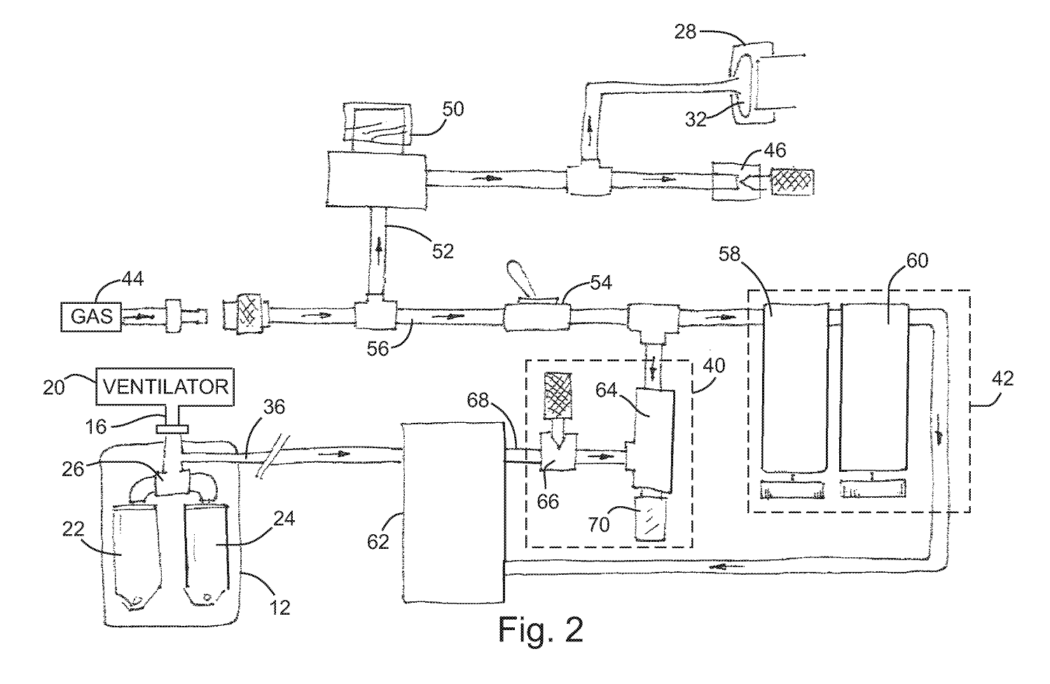

A test lung 10 is provided for a ventilator (not shown in FIG. 1, but see element 20 in FIG. 2). The test lung comprises a rigid container 12 having fixed side walls 12A, 12B, 12C and 12D, fixed bottom wall 12E and fixed top wall 12F. The rigid container may be formed at least partially from a Pelican™ brief case or other shock proof container. In some embodiments, for example when the rigid container 12 is a Pelican™ brief case or other case having a lid, the top wall 12F may be formed by a plate sealed to the walls 12A-D by a suitable gasket (not shown) extending around the inside of the walls 12A-D. The plate forming the wall 12F may be a transparent plate made of acrylic or other suitably strong material to allow students to observe the mechanism of the test lung. The rigid container 12 should be pressure tight to a working pressure above atmospheric pressure. The working pressure should be at least as high as required for operation with a conventional ventilator.

An inflow line 14 is provided in a wall, such as wall 12A of the rigid container 12, for connecting to a hose 16 from ventilator 20. A first expandable chamber 22 and a second expandable chamber 24 are disposed within the rigid container 12 and are connected via flow T 26 to receive gas passing through the inflow line 14. The chambers 22, 24 may have any suitable design for a test lung and may be bladders. A valve arrangement 28, 30 is disposed in one or more walls such as wall 12F of the rigid container 12 for convenience. The valve arrangement 28, 30 provides a controlled gas flow into and out of the rigid container 12. The valve arrangement 28, 30 includes at least a first valve 28 having a valve element 32 oriented to provide variable resistance to gas flow out of the rigid container 12. The first valve 28 may be a mushroom valve. The valve arrangement 28, 30 includes a check valve 30 oriented to prevent gas flow out of the rigid container 12 and allow gas flow into the rigid container 12. A trigger hose 36 is connected to the inflow line 14 and passes through the wall 12F through a suitable seal 38.

Referring to FIG. 2, the pneumatic control circuit shown, which may conveniently be housed in the same case as the test lung, for example within a Pelican™ case, provides variable resistance for the first valve 28, a suction mechanism 40 for the trigger hose 36 and a gas operated timing mechanism 42 for controlling flow on the trigger hose 36. Conveniently, all gas powered parts of the pneumatic control circuit may be powered by a gas source 44 such as a conventional wall air source in a medical facility or educational laboratory, which may have a pressure range from 35-75 psig for example. Variable resistance of the first valve 28 is controlled by a control valve 46 that is operable to change an amount of gas directed to the first valve 28 from the gas source 44 by manual operation of the valve 46, which may be a needle valve. Higher pressure on the first valve 28 established by closing the valve 46 provides a greater resistance to expansion of the expandable chambers 22 and 24. Use of valve 46 allows setting of the compliance of the test lung at a continuous range of values. Gas regulator 50 on the line 52 from the gas source 44 to the first valve 28 may be used to regulate downward the pressure supplied to the first valve 28 depending on the operational requirements of the first valve 28.

Gas operated timing mechanism 42 is connected to the gas source 44 via a switch 54 on line 56 that allows the timing mechanism to be turned on and off. Gas operated timing mechanism 42 includes in an embodiment a first timing module 58 that controls length of an inspiratory effort from the vacuum generator 64 and a second timing module 60 that controls frequency of an inspiratory effort from the vacuum generator 64. The gas operated timing mechanism 42 is connected via a controller 62 on the trigger hose 36 to allow or block flow through the trigger hose 36 according to settings of the timing mechanism 42.

Flow through the trigger hose 36 may be actuated by a vacuum generator 64, such as a venturi, connected to receive gas power from gas source 44 through line 56 and expel gas out through a muffler 70. A valve 66 on line 68 may be used to regulate the amount of suction provided on line 68 by vacuum generator 64. The controller 62 is a conventional controller that opens or closes line 68 depending on pneumatic signals from the timing mechanism 42.

The test lung and pneumatic trigger assembly operates in an embodiment as follows. The compliance, or the amount of effort required to expand the expandable chambers 22, 24, is set by the degree of opening of valve 28, which in turn is controlled by the amount of air diverted through valve 46. The degree of compliance may be changed as desired. The trigger may be activated by throwing switch 54. The duration and frequency of a trigger signal from the gas operated timing mechanism is set by manual setting of the modules 58 and 60. When the gas operated timing mechanism 42 sends a signal to the controller 62 to signal the initiation of an inspiratory effort, the controller 62 opens line 68 and the vacuum generator 64 causes a low pressure to develop on line 68, which causes a low pressure on trigger hose 36 and thus inflow line 14. The low pressure or suction on inflow line 14 signals to the ventilator 20 to commence an inspiratory effort. As the timing mechanism sends periodic on signals to the controller 62, the operation of the ventilator 20 may be triggered as required.

The simulated respiratory trigger and test lung is therefore capable of triggering a variety of mechanical ventilators (those that respond to an inspiratory effort in adult, pediatric and neonatal patent populations) to deliver predetermined respiratory rates that simulate a spontaneously breathing patient. This permits the student/health care provider to respond to this spontaneous effort and optimize mechanical ventilator settings.

The simulated respiratory trigger and test lung is also thus capable of varying the simulated patients pulmonary compliance in increments not previously available to the knowledge of the inventor. If delivering a preset tidal volume, patient peak airway pressures may be altered in 1 cm/H2O increments from normal adult ranges to exceedingly high values (>50 cmH2O). This is accomplished through manipulating control valve 46, which may be a single control on the exterior of the rigid container 12. Respiratory rate is also manipulated with a single control for the module 60, the control switch of which may also be conveniently located on the exterior of the rigid container 12.

The simulated respiratory trigger and test lung does not in one embodiment require a/c power but may be run on compressed air at 50 PSI, which is the routine operating pressure of mechanical ventilators and should therefore be readily available for use anywhere mechanical ventilators are in use. With the use of an air cylinder of compressed gas, the test lung and trigger could also be used in patient transport simulations.

The simulated respiratory trigger and test lung may also display and produce waveforms and physiological flow patterns that demonstrate expiratory flow limitations that are present in asthmatic or COPD patients to the student. COPD, or chronic obstructive pulmonary disease, is increasing in prevalence in our current generation. It is also possible to run the test lung alone that can still vary simulated patient compliance without the need of compressed air. The trigger would be non-functional in this configuration.

Coupling a ventilator trigger device with a new method for altering pulmonary compliance permits a degree of simulation for the student and instructor to: 1) allow students to see and respond appropriately to changing patient compliance in the adult, pediatric and neonatal patient populations, 2) allow students to see and respond to a range of patient respiratory rates from apnea (no breath rate) to tachypnea (respiratory rates as high as 40 breathes per minute), 3) have several devices set up with different parameters in a lab setting to simulate an entire hospital unit of patients, 4) provide equitable and repeatable lab testing scenarios, 5) bench testing of newly acquired ventilators in the hospital setting to ensure appropriate operation prior to using the device on patients, and 6) use the device in education of a variety of health care providers including but not limited to respiratory therapists, paramedics, physicians, physician assistants, anesthesiologists, and anesthesiologist assistants, and specific nursing programs.

In the claims, the word “comprising” is used in its inclusive sense and does not exclude other elements being present. The indefinite article “a” before a claim feature does not exclude more than one of the feature being present. Each one of the individual features described here may be used in one or more embodiments and is not, by virtue only of being described here, to be construed as essential to all embodiments as defined by the claims.

1. A test lung for a ventilator, the test lung comprising:
a rigid container having fixed walls, the rigid container being pressure tight to a working pressure above atmospheric pressure;
an inflow line in a wall of the rigid container for connecting to a hose from a ventilator;
at least a first expandable chamber disposed within the rigid container, the first expandable chamber being connected to receive gas passing through the inflow line; and
a valve arrangement disposed in one or more walls of the rigid container, the valve arrangement providing controlled gas flow into and out of the rigid container.

2. The test lung of claim 1 in which the valve arrangement includes at least a first valve having a valve element oriented to provide variable resistance to gas flow out of the rigid container.

3. The test lung of claim 2 in which variable resistance of the first valve is controlled by a control valve that is operable to change an amount of gas directed to the first valve from a gas source.

4. The test lung of claim 3 in which the first valve comprises a mushroom valve.

5. The test lung of claim 1 in which the valve arrangement includes a check valve oriented to prevent gas flow out of the rigid container and allow gas flow into the rigid container.

6. The test lung of claim 1 further comprising a pneumatic trigger for the ventilator, the pneumatic trigger comprising at least a trigger hose connected to the inflow line.

7. The test lung of claim 6 in which the pneumatic trigger comprises a gas operated timing mechanism.

8. The test lung of claim 7 in which the gas operated timing mechanism is connected via a controller on the trigger hose to allow or block flow through the trigger hose according to settings of the timing mechanism.

9. The test lung of claim 8 in which the flow through the trigger hose is actuated by a vacuum generator.

10. The test lung of claim 6 in which the rigid container houses the pneumatic trigger.

11. The test lung of claim 1 in which the rigid container comprises a shock proof brief case.

12. The test lung of claim 1 in which:
the valve arrangement includes at least a first valve having a valve element oriented to provide variable resistance to gas flow out of the rigid container, variable resistance of the first valve being controlled by a control valve that is operable to change an amount of gas directed to the first valve from a gas source;
a trigger hose connected to provide a flow line between the inflow line and a pneumatic trigger, the pneumatic trigger including a gas operated timing mechanism connected via a controller on the trigger hose to allow or block flow through the trigger hose according to settings of the timing mechanism, flow through the trigger hose being actuated by a vacuum generator; and
the gas source being connected to provide gas for the gas operated timing mechanism and to power the vacuum generator.

13. The test lung of claim 12 in which the gas source comprises a wall air source in a medical facility or educational laboratory.

14. The test lung of claim 12 in which the valve arrangement includes a check valve oriented to prevent gas flow out of the rigid container and allow gas flow into the rigid container.

15. A pneumatic trigger for a ventilator, the pneumatic trigger comprising:
at least a trigger hose connectable to a ventilator output;
a gas operated timing mechanism connected via a controller on the trigger hose to allow or block flow through the trigger hose according to settings of the timing mechanism; and
a vacuum generator on the trigger hose to provide suction on the trigger hose when the controller is set to allow flow through the trigger hose.

16. The pneumatic trigger of claim 15 in which the gas operated timing mechanism is powered by a gas source and the vacuum generator is powered by the gas source.

17. The test lung of claim 16 in which the gas source comprises a wall air source in a medical facility or educational laboratory.

18. The pneumatic trigger of claim 15 in which the gas operated timing mechanism comprises at least a first timer to control frequency of flow through the trigger hose and a second timer to control duration of flow through the trigger hose.
